(19) United States
(12) Patent Application Publication
(10) Pub. No.: US 2005/0133485 A1
(43) Pub. Date: Jun. 23, 2005

(54) Laser irradiation device and method for bending processing

(75) Inventor: Fumihiko Tokura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/041,273

(22) Filed: Jan. 25, 2005

Related U.S. Application Data
(63) Continuation of application No. PCT/JP02/12676, filed on Dec. 3, 2002.

(51) Int. Cl. B23K 26/00; B23K 26/06

(52) U.S. Cl. 219/121.6; 219/121.75

(57) ABSTRACT

A laser irradiation device and a method thereof for irradiating a laser beam onto a workpiece for bending processing are disclosed. The laser irradiation device includes a light condensing unit configured to condense an incident laser beam; a shaping optical unit configured to change the condensed laser beam from the light condensing unit to a laser beam having an elongated elliptic cross section, and irradiate the shaped laser beam onto the workpiece; and a control unit configured to adjust a relative position between the shaping optical unit and the workpiece so that a long axis of the cross section of the shaped laser beam is in coincidence with a reference line on the workpiece.

### CROSS-REFERENCE TO RELATED APPLICATION

This application is a U.S. continuation application filed under 35 USC 111(a) claiming benefit under 35 USC 120 and 365(c) of PCT application JP02/12676, filed Dec. 3, 2002. The application is hereby incorporated herein by reference.

### TECHNICAL FIELD

The present invention relates to a laser irradiation device and a method thereof for irradiating a laser beam onto a workpiece such as a metal plate or a ceramic plate for bending processing.

### BACKGROUND OF THE INVENTION

Laser bending processing is a well known method for bending a metal plate, a ceramic plate, or other workpieces being processed by utilizing thermal contraction or thermal melting effects caused by a laser beam emitted from a laser irradiation optical system. In the laser bending processing, a laser beam is irradiated onto the workpiece, and the workpiece is bent and deformed by a stress generated during thermal contraction or thermal melting and solidification.

FIG. 1 shows a laser condensing optical system for bending processing in the related art.

The optical system 1 in FIG. 1 condense a laser beam from a laser (not illustrated), and forms a laser spot (dot) 4 on a workpiece. The laser irradiation shape of this laser irradiation optical system is dot-like, and heat generated by laser irradiation spreads radially. As illustrated by arrows in FIG. 1, because of cooling following the laser irradiation, stress (causing strain, or deformation) is generated in directions from the periphery of the workpiece to the irradiation point. In the laser irradiation optical system for bending processing in the related art, this stress is used for bending and deforming the workpiece.

FIG. 2 is a view for explaining bending processing performed by using the laser condensing optical system in FIG. 1.

As illustrated in FIG. 2, in order to generate bending deformation relative to a reference line on a workpiece 2, in the laser irradiation optical system for bending processing in the related art, dot-like laser spots 4 are successively irradiated for many times on the workpiece 2, and the laser spots 4 are arranged at preset intervals along the reference line, thereby causing bending deformation of the workpiece.

However, in the bending processing laser irradiation optical system of the related art, in each bending processing on the workpiece, the laser irradiation has to be performed many times, and this results in long processing time and high cost. In addition, since the laser spots 4 are arranged along the reference line of the workpiece, two stresses in directions opposite to each other along the reference line are cancelled in the region between adjacent two laser spots 4. Due to this, an excess of laser energy is consumed compared with that required for generating desired bending deformation of the workpiece; hence, processing efficiency with laser irradiation is low.

For example, Japanese Laid Open Patent Application No. 2002-8338 and Japanese Laid Open Patent Application No. 2000-339894 disclose related art in which plural dot-like laser spots 4 are successively irradiated for multiple times to cause bending deformation of the workpiece.

### DISCLOSURE OF THE INVENTION

An object of the present invention is to solve the above problems by providing a laser irradiation device and a laser irradiation method able to improve efficiency of bending processing with laser irradiation when processing a workpiece to a desired shape by bending processing.

To solve the above problem, the present invention provides a laser irradiation device for irradiating a laser beam to a workpiece for bending processing. The laser irradiation device includes a light condensing unit configured to condense an incident laser beam; a shaping optical unit configured to change the condensed laser beam from the light condensing unit to a laser beam having an elongated elliptic cross section, and irradiate the shaped laser beam onto the workpiece; and a control unit configured to adjust a relative position between the shaping optical unit and the workpiece so that a long axis of the cross section of the shaped laser beam is in coincidence with a reference line on the workpiece.

In the laser irradiation device, the control unit may include a first stage with the shaping optical unit provided thereon; and a first driving unit configured to drive the first stage to rotate with respect to an optical axis of the shaped laser beam. The control unit controls rotation of the shaping optical unit through the first driving unit so as to adjust a rotational position of the shaping optical unit relative to the reference line on the workpiece.

In the laser irradiation device, the control unit may include a second stage with the workpiece provided thereon; and a second driving unit configured to change the relative position of the second stage relative to the shaped laser beam, the control unit being able to control the second driving unit so as to move an irradiation position of the shaped laser beam relative to the workpiece in a predetermined direction.

In the laser irradiation device, the light condensing unit may include a light condensing lens, and the shaping optical unit may include a cylindrical lens.

To solve the above problem, there is provided a laser irradiation method for irradiating a laser beam onto a workpiece for bending processing, including a step of condensing an incident laser beam by a light condensing unit; a step of changing, by a shaping optical unit, the condensed laser beam from the light condensing unit to a laser beam having an elongated elliptic cross section, and irradiating the shaped laser beam onto the workpiece; and a step of adjusting a relative position between the shaping optical unit and the workpiece so that a long axis of the cross section of the shaped laser beam is in coincidence with a reference line on the workpiece.

According to the laser irradiation device and the laser irradiation method of the present invention, control is performed so that the laser beam having an elongated elliptic cross section is irradiated onto the workpiece, and the long axis of the cross section of the shaped laser beam is in coincidence with the reference line on the workpiece. By irradiation with the shaped laser beam, the laser processing time and the number of times of laser irradiation can be reduced remarkably compared with the irradiation method of the related art which involves irradiating dot-like laser spots many times. According to the laser irradiation device and the laser irradiation method of the present invention, it is possible to improve processing efficiency with laser irradiation in a fabrication process. In addition, because the irradiation position is moved and scanned with the shape of the cross section of the shaped laser beam being unchanged, it is possible to efficiently perform bending processing on the workpiece.

The bending processing according to the laser irradiation device and the laser irradiation method of the present invention is particularly suitable for adjusting the shape of an air bearing surface of a magnetic head slider, which requires bending processing of high precision. When the bending processing according to the laser irradiation device and the laser irradiation method of the present invention is applied to the shape adjustment of the air bearing surface of the magnetic head slider, it is possible to further improve processing efficiency compared with the laser irradiation of the related art.

### BRIEF DESCRIPTION OF THE DRAWINGS

These and other objects, features, and advantages of the present invention will become more apparent with reference to the following drawings accompanying the detailed description of the present invention, in which:

FIG. 1 schematically shows a laser condensing optical system for bending processing in the related art;

FIG. 2 is a perspective view for explaining bending processing performed by using the laser condensing optical system in FIG. 1;

FIG. 3 shows a laser irradiation optical system according to an embodiment of the present invention;

FIG. 4 is a schematic diagram for explaining bending processing performed by using the laser irradiation optical system in FIG. 3;

FIG. 5 is a schematic diagram for explaining the operation of repeatedly irradiating the shaped laser beam from the laser irradiation optical system in FIG. 3 to the workpiece to perform the bending processing;

FIG. 6 shows a configuration of a bending processing apparatus utilizing the laser irradiation device of the embodiment of the present invention;

FIG. 7A and FIG. 7B are perspective views showing a comparison between the processing efficiency of laser irradiation using multiple laser spots as in the related art and the processing efficiency of laser irradiation using a laser beam having an elongated elliptic cross section according to the present invention;

FIG. 8 is a perspective view showing a configuration of a magnetic head slider with the present invention being applied thereto;

FIG. 9A and FIG. 9B are views showing examples of bending processing of the magnetic head slider in FIG. 8 by using the laser irradiation optical system of the present invention; and

FIG. 10 is a plan view showing a laser irradiation method according to an embodiment of the present invention used in bending processing of the magnetic head slider in FIG. 8.

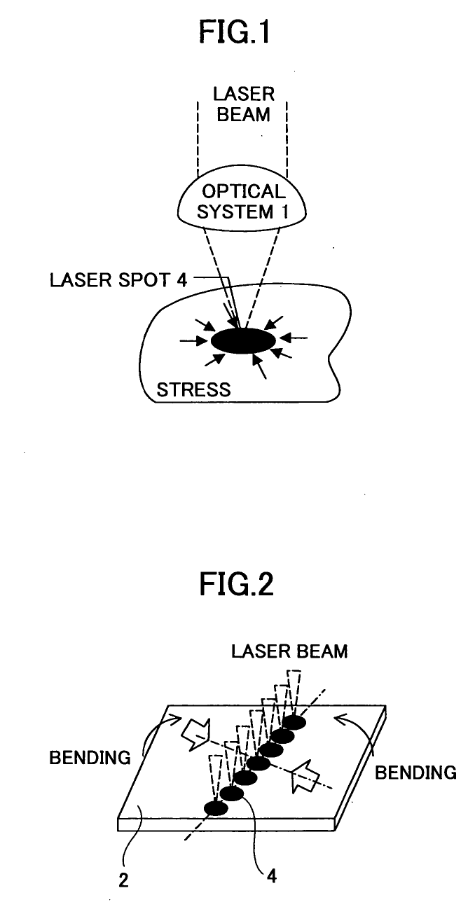

### BEST MODE FOR CARRYING OUT THE INVENTION

Below, embodiments of the present invention are explained with reference to the accompanying drawings.

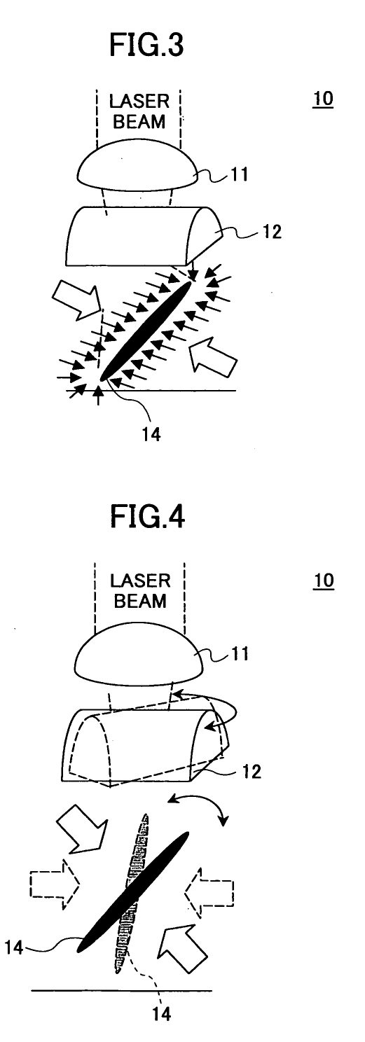

FIG. 3 shows a laser irradiation optical system 10 according to an embodiment of the present invention.

FIG. 4 is a view for explaining bending processing performed by using the laser irradiation optical system 10 in FIG. 3.

As illustrated in FIG. 3, the laser irradiation optical system 10 according to the present embodiment includes a light condensing optical unit 11 for condensing an incident laser beam; a shaping optical unit 12 for changing the condensed laser beam from the light condensing unit 11 to a laser beam having an elongated elliptic cross section, and irradiating the shaped laser beam onto a workpiece to be processed. In the present embodiment, in the laser irradiation device, the light condensing optical unit 11 may include a condensing lens, and the shaping optical unit 12 may include a cylindrical lens. The cylindrical lens 12 of the present embodiment is an optical element having functions of changing the incident laser beam to a laser beam having an elongated elliptic cross section, but other elements having the same functions may also be used.

When the laser irradiation optical system 10 irradiates a shaped laser beam 14 onto the workpiece, due to cooling after the laser irradiation, as illustrated by arrows in FIG. 3, in the workpiece, stresses (causing deformation), which intersect with the long axis of the elongated elliptic shape and are respectively in two directions facing each other, are generated uniformly. Bending processing of the workpiece is performed by utilizing the stresses. With the laser irradiation method of the related art, it is necessary for dot-like laser spots 4 to be successively irradiated for laser irradiation of many times repeatedly; in contrast, according to the laser irradiation method of the present invention, it is sufficient to perform laser irradiation once in order to generate uniform bending deformation in the workpiece.

In laser irradiation as in the related art, which results in plural dot-like laser spots successively arranged, since in the region between adjacent two laser spots, along the reference line of the workpiece, two stresses are generated to be in directions opposite to each other and to be cancelled, excessive laser energy is consumed. Compared with the related art, the present invention can reduce laser energy consumption required by bending processing.

By irradiation with the shaped laser beam, laser processing time and the number of times of laser irradiation can be reduced remarkably compared with the irradiation method of the related art which involves irradiating dot-like laser spots for many times. Therefore, according to the present invention, it is possible to improve processing efficiency with laser irradiation in a fabrication process.

A laser irradiation device according to the present embodiment has the laser irradiation optical system 10 shown in FIG. 3 and a control unit (not illustrated), and irradiates a shaped laser beam 14 from the laser irradiation optical system 10 to the workpiece for bending processing. As illustrated in FIG. 4, the control unit adjusts the relative position between the shaping optical unit 12 and the workpiece so that a long axis of the cross section of the shaped laser beam 14 is in coincidence with the reference line on the workpiece.

For example, the workpiece is mounted on a work stage, the shaping optical unit 12 is mounted on a rotational stage, and the control unit is able to control rotation driving operations of the rotational stage. The laser irradiation device according to the present invention controls rotational positions of the shaping optical unit 12 with respect to the optical axis of the condensed laser beam incident from the light condensing optical unit 11, so that a long axis of the cross section of the shaped laser beam 14 is in coincidence with the reference line on the workpiece. Then, in order to control the bending deformation of the workpiece, the shaping optical unit 12 and the control unit change the laser irradiation shape and the laser irradiation method corresponding to the desired bending deformation to generate the desired bending deformation of the workpiece.

In addition, as illustrated in FIG. 4, when changing the direction and magnitude of the bending deformation of the workpiece, by driving the cylindrical lens 12 arranged on the optical axis to rotate and move, it is possible to change the laser irradiation shape, or the shape of the cross section of the shaped laser beam 14.

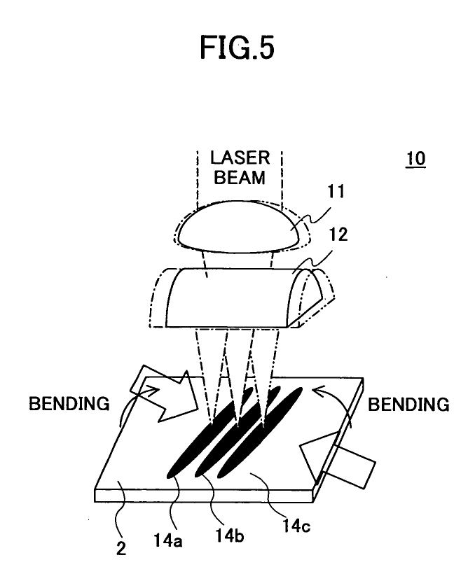

FIG. 5 is a view for explaining the operation of repeatedly irradiating the shaped laser beam from the laser irradiation optical system in FIG. 3 onto the workpiece to perform the bending processing.

As illustrated in FIG. 5, when the laser irradiation device of the present invention changes the magnitude of the bending deformation of the workpiece, the laser irradiation device changes the irradiation position of the shaped laser beam 14 from the laser irradiation optical system 10.

In the example in FIG. 5, in order to increase the magnitude of the bending deformation of the workpiece 2, the laser irradiation is performed on the workpiece 2 each time the position of the laser irradiation optical system 10 is translated in a direction parallel to a reference line on the workpiece 2 and by a preset distance exactly relative to the workpiece 2. Due to this, the irradiation position on the workpiece 2 is shifted, and shaped laser beams 14a, 14b, and 14c are formed. Because these shaped laser beams are formed to be sufficiently close to each other, the magnitude of the bending deformation of the workpiece 2 is increased. In order to adjust the magnitude of the bending deformation of the workpiece 2 to be an appropriate value, it is necessary to set in advance the number of times of the irradiation of the shaped laser beams 14.

In order to realize the above functions, for example, by using a laser irradiation device in which the work stage on which the workpiece is mounted is to be fixed in advance, and the laser irradiation is carried out repeatedly while translating, by a driving mechanism, the stage on which the laser irradiation optical system 10 is mounted.

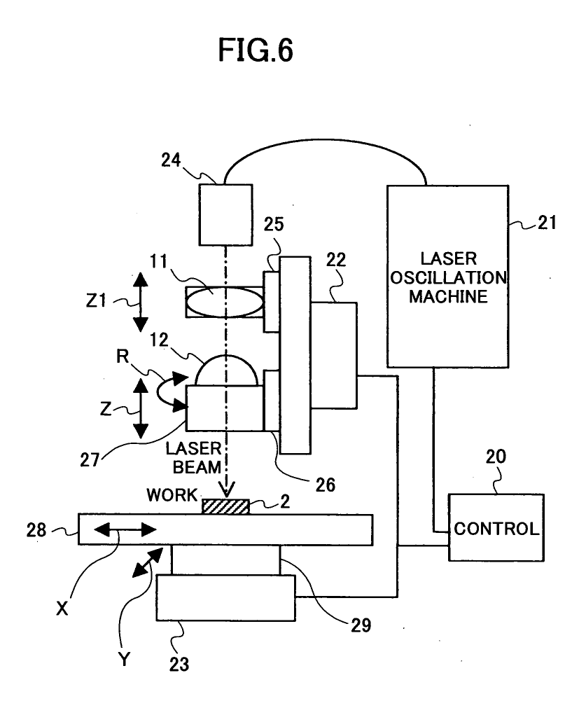

FIG. 6 shows a configuration of a bending processing apparatus utilizing the laser irradiation device of the embodiment of the present invention.

The bending processing apparatus in FIG. 6 includes a controller 20, a laser oscillator 21, an optical system stage driver 22, a work stage driver 23, a laser 24, a first Z stage 25, a second Z stage 26, a rotational stage 27, a work stage 28, and an XY table 29. The workpiece 2, which is to be processed by bending processing, is mounted on the work stage 28.

The light condensing optical unit 11 of the laser irradiation optical system 10 of the present embodiment is mounted on the first Z stage 25, and by moving the first Z stage 25 in the Z direction (the direction perpendicular to the laser incident surface of the workpiece 2), the position of the light condensing optical unit 11 can be changed along the optical axis of the incident laser beam from the laser 24. The cylindrical lens 12 is mounted on the rotational stage 27, and by rotating the rotational stage 27, the rotational position of the cylindrical lens 12 can be changed with respect to the optical axis of the incident laser beam from the laser 24. In addition, the rotational stage 27 is mounted on the second Z stage 26. By moving the second Z stage 26 in the Z direction, the position of the cylindrical lens 12 can be changed along the optical axis of the incident laser beam from the laser 24.

As described above, the light condensing optical unit 11 of the laser irradiation optical system 10 of the present embodiment, the cylindrical lens 12, and the workpiece 2 are arranged along the optical axis of the incident laser beam from the laser 24, as illustrated in FIG. 5.

In the bending processing apparatus in FIG. 6, the controller 20 transmits control signals to different sections following a predetermined procedure to control operations of the laser oscillator 21, the optical system stage driver 22, and the work stage driver 23.

The laser oscillator 21 receives the control signal from the controller 20, and drives the laser 24 to emit a laser beam to the laser irradiation optical system 10.

The optical system stage driver 22 receives the control signal from the controller 20, and drives the first Z stage 25, the second Z stage 26, and the rotational stage 27. The first Z stage 25 is driven by the optical system stage driver 22, and thereby, the relative position of the light condensing optical unit 11 with respect to the laser 24 can be moved in the Z direction by a specified distance, as indicated by an arrow Z1. In addition, the rotational stage 27 is driven by the optical system stage driver 22, and thereby, the rotational position of the cylindrical lens 12 with respect to the optical axis of the laser beam can be changed by a specified angle, as indicated by an arrow R. Further, the second Z stage 26 is driven by the optical system stage driver 22, and thereby, the relative position of the cylindrical lens 12 with respect to the laser 24 can be moved in the Z direction by a specified distance, as indicated by an arrow Z.

The work stage driver 23 receives the control signal from the controller 20, and drives the work stage 28 and the XY table 29, so that the relative position of the workpiece 2 with respect to the optical axis of the laser beam from the laser irradiation optical system 10 can be changed in the X direction and Y direction, respectively.

In the bending processing apparatus in FIG. 6, the controller 20, the optical system stage driver 22, the rotational stage 27, the work stage driver 23 and the work stage 28 correspond to the control unit of the laser irradiation device according to the present invention.

That is, in the laser irradiation device of the present embodiment, which is applied to the bending processing apparatus in FIG. 6, the controller 20 includes the rotational stage 27 on which the cylindrical lens 12 is installed, and the optical system stage driver 22 which drives the rotational stage 27 to rotate with respect to the optical axis of the shaped laser beam. The controller 20 controls rotation of the cylindrical lens 12 through the optical system stage driver 22 so as to adjust the rotational position of the cylindrical lens 12 relative to the reference line on the workpiece 2.

In addition, in the laser irradiation device of the present embodiment, which is applied to the bending processing apparatus in FIG. 6, the controller 20 includes the work stage 28 on which the workpiece 2 is mounted, and the work stage driver 23 which changes the position of the work stage 28 relative to the shaped laser beam. The controller 20 controls the work stage driver 23 so as to change the irradiation position of the shaped laser beam relative to the workpiece 2 in a predetermined direction.

As described above, by irradiation of the shaped laser beam with the laser irradiation device of the present embodiment, laser processing time and the number of times of laser irradiation can be reduced remarkably compared with the irradiation method of the related art which involves irradiating dot-like laser spots many times. Therefore, according to the laser irradiation device of the present embodiment, it is possible to improve processing efficiency with laser irradiation in a fabrication process.

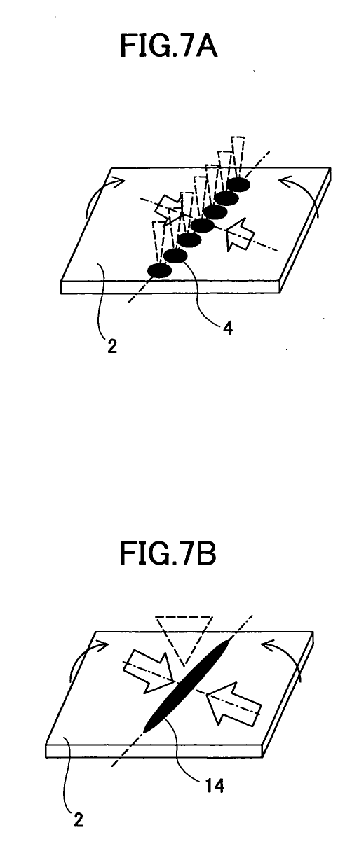

FIG. 7A and FIG. 7B are views showing a comparison between processing efficiency of laser irradiation using multiple laser spots as in the related art and processing efficiency of laser irradiation using a laser beam having an elongated elliptic cross section according to the present invention, when the same bending processing is performed on the same workpiece.

In the examples, description is made assuming bending processing having the same magnitude is generated relative to the reference line on the workpiece 2. In the two examples, it is assumed that the laser irradiation time in each laser irradiation is a constant value (t1).

In the example of the related art in FIG. 7A, dot-like laser spots 4 (the diameter of each dot is about 80 μm) are successively irradiated for seven times along the reference line on the workpiece 2, and the laser spots 4 are arranged at preset intervals, thereby causing certain bending deformation of the workpiece 2. The processing efficiency T1 of laser irradiation in this example is defined to be a product of the laser irradiation time in each laser irradiation (t1) and the number of times of laser irradiation (7).

In contrast, in the example of the present invention in FIG. 7B, a shaped laser beam 14 having an elongated elliptic cross section (an elliptic cross section with a long diameter of 200 μm and a short diameter of 60 μm), is irradiated once while the long axis of the cross section of the shaped laser beam is in coincidence with the reference line on the workpiece 2, thereby causing predetermined bending deformation of the workpiece 2. The processing efficiency T2 of laser irradiation in this example is defined to be a product of the laser irradiation time in each laser irradiation (t1) and the number of times of laser irradiation (1).

Because the laser processing time is influenced by the number of times of laser irradiation in the fabrication process, by using a laser beam having an elongated elliptic cross section as in the present invention, the number of times of laser irradiation is much less than the bending processing of the related art, hence, it is possible to increase the speed of the act of laser processing.

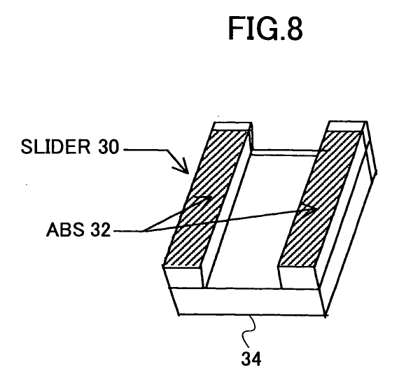

FIG. 8 is a view showing a configuration of a magnetic head slider with the present invention being applied thereto.

The magnetic head slider 30 in FIG. 8 is a part installed in the front end of a magnetic head of a magnetic disk device (not illustrated). On the surface of the slider 30, there is formed an air bearing surface (abbreviated to be “ABS” below) 32 facing a rotating magnetic disk and flying over a surface of the magnetic disk. Because of the ABS 32, the distance between the magnetic disk and the slider 30, that is, flying height, is maintained to be a constant. In order to stabilize operations of the magnetic head for recording data to or reproducing data from the magnetic disk, it is important that the surface of the ABS 32 of the slider 30 not be distorted but be adjusted to be a predetermined curved surface.

The distortion of the ABS 32 of the slider 30 is evaluated by measuring a Crown value indicating distortion in a direction parallel to the rotational direction of the magnetic disk, a Camber value indicating distortion in a direction perpendicular to the rotational direction of the magnetic disk, and a Twist value indicating distortion in a twisted direction relative to the rotational direction of the magnetic disk.

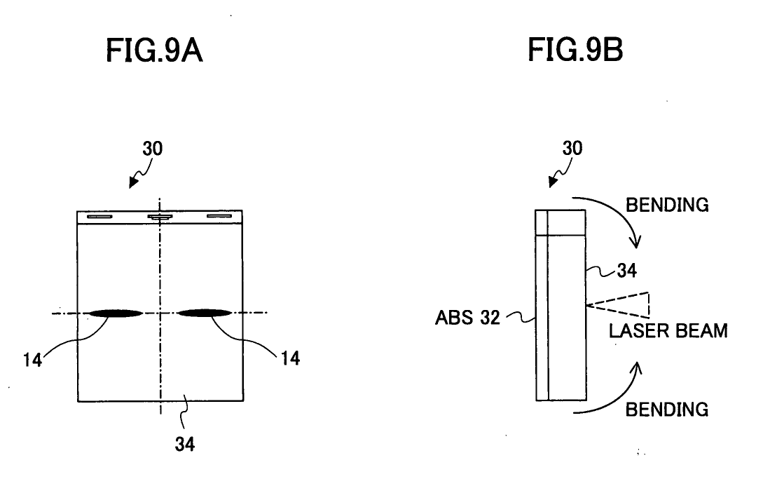

FIG. 9A and FIG. 9B are views showing examples of bending processing performed by using the laser irradiation optical system according to the present invention in the magnetic head slider in FIG. 8. FIG. 9A illustrates a back surface of the magnetic head slider 30 in FIG. 8, and FIG. 9B illustrates a side surface of the magnetic head slider 30 in FIG. 8.

In the present embodiment, in order to precisely adjust the surface shape of the ABS 32 of the magnetic head slider 30 to be a predetermined curved surface, a laser beam from the laser irradiation optical system according to the present invention is irradiated on to the back surface 34 of the slider 30, and bending deformation is caused by a thermal expansion and contraction stress or thermal melting and solidification stress, and thus, the surface shape of the ABS 32 of the magnetic head slider 30 is adjusted by bending processing.

As illustrated in FIG. 9A, reference lines in the longitudinal direction and lateral direction cross with each other at the center of the back surface 34 of the slider 30, and the shaped laser beam 14 having an elongated elliptic cross section according to the present invention is irradiated at two bilaterally symmetric locations along the lateral reference line among the reference lines. Thus, bending deformation due to stress, as illustrated in FIG. 7, occurs on the back surface 34 of the slider 30.

As illustrated in FIG. 9B, by appropriately controlling the number of times of laser irradiation and the energy of laser irradiation, the surface shape of the ABS 32 of the magnetic head slider 30 is adjusted to be a predetermined curved surface by bending deformation relative to the lateral reference line (the bending deformation indicated by arrows in FIG. 9B). In this example, the shaped laser beam 14 is irradiated onto the back surface 34 twice, thereby, the Crown value is adjusted among the distortion states of the surface shape of the ABS 32 of the slider 30.

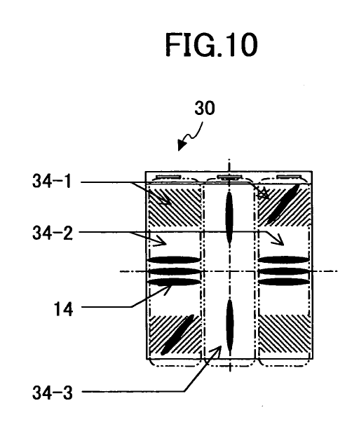

FIG. 10 is a view showing a laser irradiation method according to an embodiment of the present invention used in bending processing of the magnetic head slider in FIG. 8.

As illustrated in FIG. 10, different laser irradiation areas are defined on the back surface 34 of the ABS 32 of the slider 30 for separately adjusting the Crown value, Camber value, and Twist value used for evaluating the surface shape of the ABS 32 of the magnetic head slider 30. Specifically, laser irradiation areas 34-1 are defined at the four corners of the back surface 34 of the slider 30 for adjusting the Twist value. Among the longitudinal reference line and the lateral reference line which cross with each other at the center of the back surface 34 of the slider 30, two bilaterally symmetric locations along the lateral reference line are defined to be laser irradiation areas 34-2 for adjusting the Crown value, and two longitudinally symmetric locations along the longitudinal reference line are defined to be laser irradiation areas 34-3 for adjusting the Camber value,

The laser irradiation time required in each laser irradiation is set to be a constant value, and the laser irradiation device is adjusted so as to form, for example, a shaped laser beam 14 having an elongated elliptic cross section of a long diameter of 200 μm and a short diameter of 60 μm. The number of times of laser irradiation required for adjusting the surface shape of the ABS 32 of the magnetic head slider 30 to be a predetermined curved surface may be decided in advance as illustrated in FIG. 10.

According to the laser irradiation method of the present embodiment, by rotating the cylindrical lens 12 arranged on the optical axis of the incident laser beam with respect to the direction of the bending deformation of the workpiece (Crown, Camber, Twist) to change the laser irradiation shape to a state corresponding to the bending direction, it is possible to control the direction of the bending deformation.

According to the laser irradiation method of the present embodiment, because control is performed such that a shaped laser beam having an elongated elliptic cross section is irradiated to the workpiece, and the long axis of the cross section of the shaped laser beam is in coincidence with the reference line on the workpiece, the laser processing time and the number of times of laser irradiation can be reduced remarkably comparing with the irradiation method of the related art which involves irradiating dot-like laser spots many times.

According to the laser irradiation method of the present embodiment, it is possible to improve processing efficiency with laser irradiation in a fabrication process. Further, because the irradiation position is moved and scanned with the shape of the cross section of the shaped laser beam being unchanged, it is possible to efficiently perform bending processing on the workpiece.

The bending processing according to the laser irradiation method of the present invention is particularly suitable for adjusting the shape of an air bearing surface of a magnetic head slider, which requires bending processing of high precision. When the bending processing according to the present laser irradiation method is applied to the shape adjustment of the air bearing surface of the magnetic head slider, because larger bending deformation can be generated than that obtained by the irradiation method of the related art using dot-like laser spots, it is possible to further improve processing efficiency.

While the invention has been described with reference to preferred embodiments, the invention is not limited to these embodiments, but numerous modifications could be made thereto without departing from the basic concept and scope described in the claims.

1. A laser irradiation device for irradiating a laser beam onto a workpiece for bending processing, comprising:
a light condensing unit configured to condense an incident laser beam;
a shaping optical unit configured to change the condensed laser beam from the light condensing unit to a laser beam having an elongated elliptic cross section, and irradiate the shaped laser beam onto the workpiece; and
a control unit configured to adjust a relative position between the shaping optical unit and the workpiece so that a long axis of the cross section of the shaped laser beam is in coincidence with a reference line on the workpiece.

2. The laser irradiation device as claimed in the claim 1, wherein
the control unit includes:
a first stage with the shaping optical unit provided thereon; and
a first driving unit configured to drive the first stage to rotate with respect to an optical axis of the shaped laser beam;
wherein the control unit controls rotation of the shaping optical unit through the first driving unit so as to adjust a rotational position of the shaping optical unit relative to the reference line on the workpiece.

3. The laser irradiation device as claimed in the claim 1, wherein
the control unit includes:
a second stage with the workpiece provided thereon; and
a second driving unit configured to change the relative position of the second stage relative to the shaped laser beam;
wherein the control unit controls the second driving unit so as to move an irradiation position of the shaped laser beam relative to the workpiece in a predetermined direction.

4. The laser irradiation device as claimed in the claim 1, wherein the light condensing unit includes a light condensing lens, and the shaping optical unit includes a cylindrical lens.

5. A laser irradiation method for irradiating a laser beam onto a workpiece for bending processing, comprising:
a step of condensing an incident laser beam by a light condensing unit;
a step of changing, by a shaping optical unit, the condensed laser beam from the light condensing unit to a laser beam having an elongated elliptic cross section, and irradiating the shaped laser beam onto the workpiece; and
a step of adjusting a relative position between the shaping optical unit and the workpiece so that a long axis of the cross section of the shaped laser beam is in coincidence with a reference line on the workpiece.
